(19) United States
(12) Patent Application Publication
(10) Pub. No.: US 2020/0187239 A1
(43) Pub. Date: Jun. 11, 2020

(54) MULTI-STAGE SCHEDULING FOR DOWNLINK AND UPLINK TRANSMISSIONS

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Jing SUN, San Diego, CA (US); Tao LUO, San Diego, CA (US); Peter GAAL, San Diego, CA (US)

(21) Appl. No.: 16/703,604

(22) Filed: Dec. 4, 2019

Related U.S. Application Data
(60) Provisional application No. 62/776,909, filed on Dec. 7, 2018.

(51) Int. Cl. H04W 72/12; H04L 5/00; H04W 72/14

(52) U.S. Cl. CPC H04W 72/1289; H04W 72/14; H04L 5/0055

(57) ABSTRACT

A method of scheduling uplink and downlink packet transmission in a mobile communication system is disclosed. The method of scheduling includes receiving (or transmitting if from a BS perspective) a first scheduling indication and receiving (or transmitting if from a BS perspective) a second scheduling indication, the first scheduling indication and the second scheduling indication comprise scheduling information for a UE.

### CROSS-REFERENCE TO RELATED APPLICATIONS

The present application for patent claims the benefit of Provisional Application No. 62/776,909 entitled “MULTI-STAGE SCHEDULING FOR DOWNLINK AND UPLINK TRANSMISSIONS” filed Dec. 7, 2018, assigned to the assignee hereof, and expressly incorporated herein by reference in its entirety.

### FIELD OF DISCLOSURE

This disclosure relates generally to wireless communication systems, and more specifically, but not exclusively, to scheduling for a downlink (DL) and an uplink (UL) transmission.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Scheduling of UE uplink and downlink transmissions are important functions with the wireless system. There are a couple of Data Transmission Scheduling Schemes in LTE. The most simple in terms of algorithm would be the persistent scheduling. In this scheduling mode, the network sends ‘Grant’ in Downlink Control Information (DCI) Format 0 for every subframe.
i) Network sends the first data on a DL physical downlink shared channel (PDSCH) and physical downlink control channel (PDCCH) which has DCI format 1 for DL Data Decoding and DCI format 0 for UL Grant. (If there is no downlink data to be transmitted, network transmits only DPCCH with DCI format 0 without any DPSCH data)
ii) UE decodes PCFICH to figure CFI value
iii) UE decodes PDCCH and get the information on DCI format 1
iv) Based on DCI format 1, UE decodes DL data.
v) UE decodes the information on DCI format 0 from PDCCH
vi) UE sends ACK/NAK for DL data through UCI (UCI will be carried by PUCCH)
vii) UE checks the Grant field.
viii) If Grant is allowed, UE transmit the uplink data through PUSCH
ix) Network decodes PUSCH data and sends ACK/NACK via PHICH
x) UE decodes PHICH and retransmits the data if PHICH carries NACK

Another scheme is Non Persistent Scheduling. In Persistent Scheduling mode, UE can send the data to the Network anytime since the Network is sending UL Grant all the time. But if the Network does not send a UL Grant all the time, the UE has to ask the network to send UL Grant (DCI 0). If the network sends a UL Grant, then the UE can send UL data as allowed by the UL Grant. Overall procedure is as follows:
i) UE sends SR (Scehduling Request) on PUCCH
ii) Network sends UL Grant (DCI 0) on PDCCH
iii) UE decodes DCI 0 and transmit PUSCH based on the RBs specified by DCI 0
iv) Network decodes the PUSCH
v) Network sends ACK/NACK on PHICH
vi) If Network sends NACK, go to step i)

However, conventional scheduling schemes rely on DCI based scheduling grants that consume a lot of overhead in terms of the amount of data in the DCI packet for the scheduling grant and in the number of scheduling packets transmitted/received per time period.

Accordingly, there is a need for systems, apparatus, and methods that overcome the deficiencies of conventional approaches, such as reducing the DCI overhead associated with scheduling grants, including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method of operating an user equipment (UE) includes: receiving, by a UE, a first scheduling indication, the first scheduling indication comprising a set of allowed configurations and is one of a radio resource control configuration, a media access control element, a first DCI, or a first semi-persistent scheduling indication; receiving, by the UE, a second scheduling indication, the second scheduling indication comprising a selection from the set of allowed configurations; and transmitting or receiving, by the UE, data based on the first scheduling indication and the second scheduling indication.

In another aspect, a method of operating an user equipment (UE) includes: receiving, by a UE, a first scheduling indication, the first scheduling indication comprising a first set of scheduling fields and is one of a radio resource control configuration, a media access control element, or a first DCI; receiving, by the UE, a second scheduling indication, the second scheduling indication comprising a second set of scheduling fields; and transmitting or receiving, by the UE, data based on the first scheduling indication and the second scheduling indication.

In still another aspect, an user equipment (UE) includes: a processor; a memory coupled to the processor; and an antenna coupled to the processor; wherein the processor is configured to perform a method comprising: receiving a first scheduling indication, the first scheduling indication comprising a set of allowed configurations and is one of a radio resource control configuration, a media access control element, a first DCI, or a first semi-persistent scheduling indication; receiving a second scheduling indication, the second scheduling indication comprising a selection from the set of allowed configurations; and transmitting or receiving data based on the first scheduling indication and the second scheduling indication.

In still another aspect, an user equipment (UE) includes: a processor; a memory coupled to the processor; and an antenna coupled to the processor; wherein the processor is configured to perform a method comprising: receiving a first scheduling indication, the first scheduling indication comprising a first set of scheduling fields and is one of a radio resource control configuration, a media access control element, or a first DCI; receiving a second scheduling indication, the second scheduling indication comprising a second set of scheduling fields; and transmitting or receiving data based on the first scheduling indication and the second scheduling indication.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary wireless communications system in accordance with some examples of the disclosure;

FIGS. 2A and 2B illustrate example wireless network structures in accordance with some examples of the disclosure;

FIG. 3 illustrates an exemplary base station and an exemplary user equipment (UE) in an access network in accordance with some examples of the disclosure;

FIG. 4 illustrates an exemplary multi-stage scheduling in accordance with some examples of the disclosure;

FIG. 5 illustrates a first exemplary process for configuring a UE or BS in accordance with some examples of the disclosure;

FIG. 6 illustrates a second exemplary process for configuring a UE or BS in accordance with some examples of the disclosure; and

FIG. 7 illustrates a third exemplary process for configuring a UE or BS in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. Examples herein provide apparatus and methods for reducing DCI overhead in scheduling indication activities. In one example, the DCI overhead is reduced through multi-stage scheduling (e.g., two stage) when the first stage is sent to the UE less frequently while the second stage may be updated more often and potentially per grant wherein the first stage and second stage together determine the necessary scheduling information. The first stage may be RRC, MCA CE, or another DCI while the second stage may be a conventional DCI packet with smaller overhead (e.g., payload).

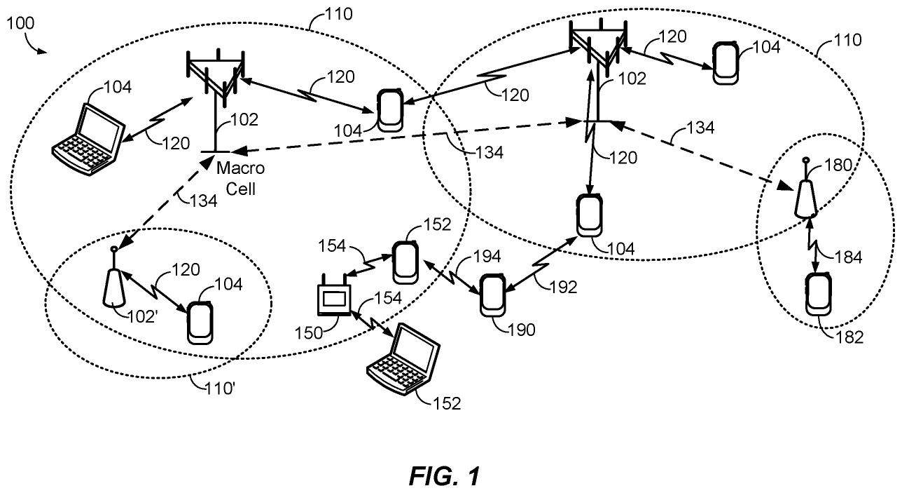

According to various aspects, FIG. 1 illustrates an exemplary wireless communications system 100. The wireless communications system 100 (which may also be referred to as a wireless wide area network (WWAN)) may include various base stations 102 and various UEs 104. The base stations 102 may include macro cells (high power cellular base stations) and/or small cells (low power cellular base stations), wherein the macro cells may include Evolved NodeBs (eNBs), where the wireless communications system 100 corresponds to an LTE network, or gNodeBs (gNBs), where the wireless communications system 100 corresponds to a 5G network or a combination of both, and the small cells may include femtocells, picocells, microcells, etc.

The base stations 102 may collectively form a Radio Access Network (RAN) and interface with an Evolved Packet Core (EPC) or Next Generation Core (NGC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, coverage areas 110 may be subdivided into a plurality of cells (e.g., three), or sectors, each cell corresponding to a single antenna or array of antennas of a base station 102. As used herein, the term “cell” or “sector” may correspond to one of a plurality of cells of a base station 102, or to the base station 102 itself, depending on the context.

While neighboring macro cell geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cells may be known as a heterogeneous network. A heterogeneous network may also include Home eNBs (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the embodiment of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D radio access technology (RAT), such as LTE Direct (LTE-D), WiFi Direct (WiFi-D), Bluetooth, and so on.

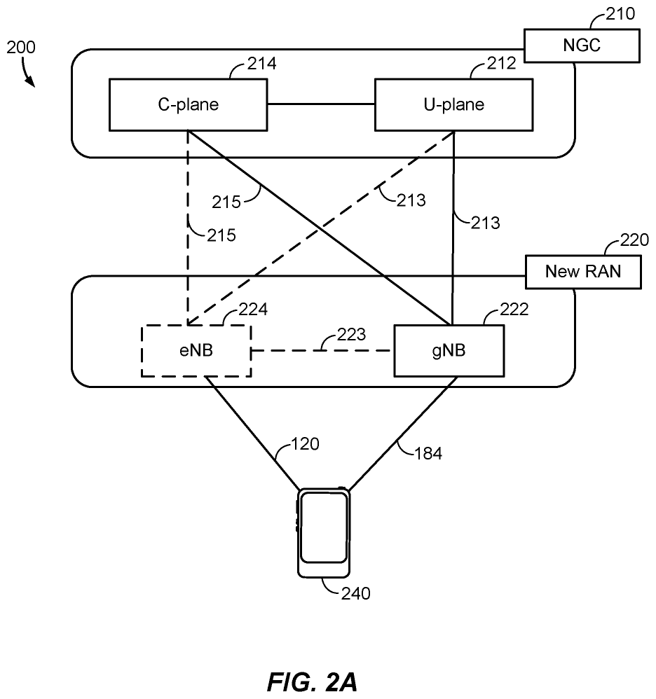

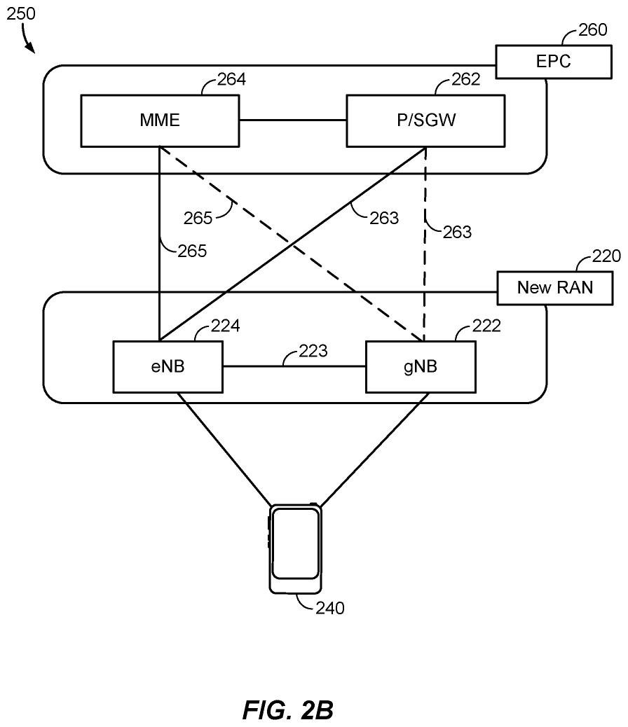

According to various aspects, FIG. 2A illustrates an example wireless network structure 200. For example, a Next Generation Core (NGC) 210 can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. Accordingly, in some configurations, the New RAN 220 may only have one or more gNBs 222, while other configurations include one or more of both eNBs 224 and gNBs 222. Either gNB 222 or eNB 224 may communicate with UEs 240 (e.g., any of the UEs depicted in FIG. 1, such as UEs 104, UE 182, UE 190, etc.).

According to various aspects, FIG. 2B illustrates another example wireless network structure 250. For example, Evolved Packet Core (EPC) 260 can be viewed functionally as control plane functions, Mobility Management Entity (MME) 264 and user plane functions, Packet Data Network Gateway/Serving Gateway (P/SGW) 262, which operate cooperatively to form the core network. S1 user plane interface (S1-U) 263 and S1 control plane interface (S1-MME) 265 connect the eNB 224 to the EPC 260 and specifically to MME 264 and P/SGW 262. In an additional configuration, a gNB 222 may also be connected to the EPC 260 via 5l-MME 265 to MME 264 and S1-U 263 to P/SGW 262. Further, eNB 224 may directly communicate to gNB 222 via the backhaul connection 223, with or without gNB direct connectivity to the EPC 260. Accordingly, in some configurations, the New RAN 220 may only have one or more gNBs 222, while other configurations include one or more of both eNBs 224 and gNBs 222. Either gNB 222 or eNB 224 may communicate with UEs 240 (e.g., any of the UEs depicted in FIG. 1, such as UEs 104, UE 182, UE 190, etc.).

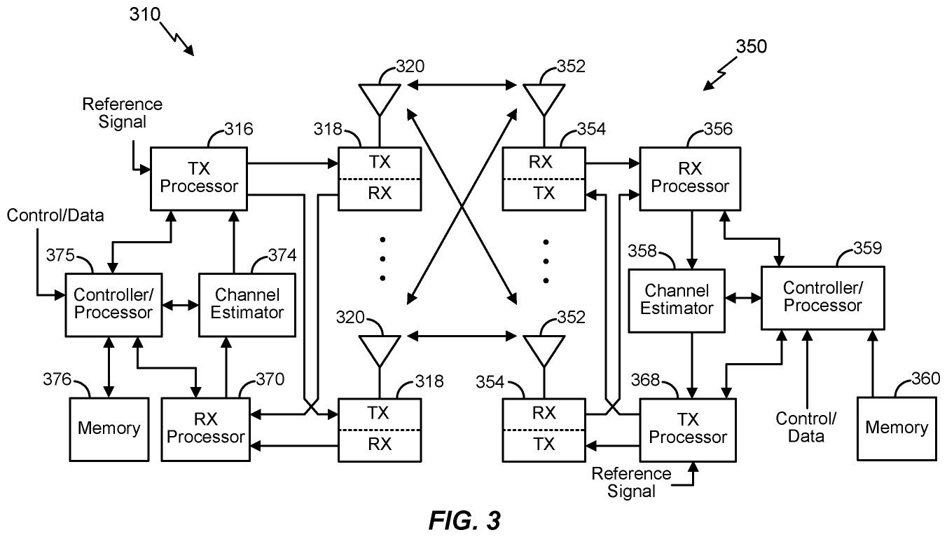

According to various aspects, FIG. 3 illustrates an exemplary base station 310 (e.g., an eNB, a gNB, a small cell AP, a WLAN AP, etc.) in communication with an exemplary UE 350 in a wireless network. In the DL, IP packets from the core network (NGC 210/EPC 260) may be provided to a controller/processor 375. The controller/processor 375 implements functionality for a radio resource control (RRC) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmit (TX) processor 316 and the receive (RX) processor 370 implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to one or more different antennas 320 via a separate transmitter 318TX. It should be understood that antennas 320 may be multi-port antennas, such as the four and eight port antennas described herein. Each transmitter 318TX may modulate an RF carrier with a respective spatial stream for transmission.

At the UE 350, each receiver 354RX receives a signal through its respective antenna 352. It should be understood that antenna 352 may be a multi-port antenna, such as the four and eight port antennas described herein. Each receiver 354RX recovers information modulated onto an RF carrier and provides the information to the RX processor 356. The TX processor 368 and the RX processor 356 implement Layer-1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and de-interleaved to recover the data and control signals that were originally transmitted by the base station 310 on the physical channel. The data and control signals are then provided to the controller/processor 359, which implements Layer-3 and Layer-2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the core network. The controller/processor 359 is also responsible for error detection.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the core network. The controller/processor 375 is also responsible for error detection.

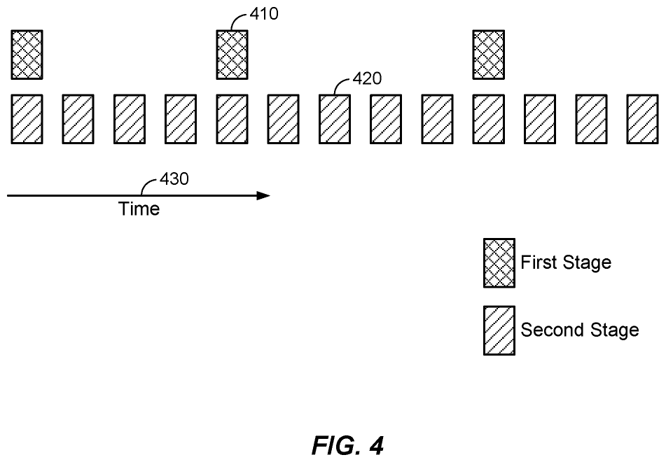

FIG. 4 illustrates an exemplary multi-stage scheduling in accordance with some examples of the disclosure. As shown in FIG. 4, configuring a UE (e.g., UE 104, 240, and 350) for uplink and downlink transmission scheduling may use multi-stage scheduling indications such as a first scheduling indication 410 and a second scheduling indication 420. As may be seen in FIG. 4, the number of transmitted or received first scheduling indications 410 versus the number or transmitted or received second scheduling indications 420 is smaller over time 430. It should be understood that while two stages are shown, more than two stages may be used. Use of multi-stage scheduling indications may allow the reduction in overhead for the scheduling indication transmission. In conventional systems, DCIs on a physical downlink control channel (PDCCH) are used for conveying the scheduling information to the UE for physical uplink shared channel/physical downlink shared channel (PUSCH/PDSCH) scheduling. Different scheduling fields (a.k.a. DCI fields) of the scheduling indication convey different information. For example, there may be different fields for frequency/time domain resource assignment, modulation and coding scheme (MCS), etc. In an effort to reduce the overhead generated in the scheduling indication process, the overhead associated with the scheduling indication (DCI, for example) may be reduced through two-stage (multi-stage) scheduling. In this example, the first stage (first scheduling indication) is sent to the UE less frequently while the second stage (second scheduling indication) needs to be updated more often and potentially per grant. The first stage and second stage together determine the necessary scheduling information. In addition, the first stage may be a radio resource configuration (RRC), media access control element (MAC CE), or another DCI. The second stage may be a regular DCI with smaller overhead. The benefit is to reduce the overhead of control signaling (e.g., less DCI overhead) as shown herein where the first stage is sent less frequently than a conventional single stage scheduling indication and the second stage contains less data or information than a conventional single stage grant.

Different mechanisms may be used for multi-stage scheduling. The following are examples of such mechanisms along with various alternatives that may be combined as desired. In a first option (e.g., partial process 500), the first scheduling indication may indicate a set of allowed values/configurations. The second scheduling indication may point to one of the members/indices of the set allowed by the first scheduling indication. This may be done per scheduling field or a collection of scheduling fields. The set may be a table with each entry/row indicating a combination of scheduling fields, and second scheduling indication may point to one of the rows of the table. For example, the first scheduling indication can limit the freq. domain assignment to a set of 8 possibilities (table with 8 rows, where each row determines RBs for scheduling), and second scheduling indication points to one of the 8 rows in the table through a 3-bit field.

Alternatively, multiple tables may be indicated by the first scheduling indication, where each table covers a one or more scheduling fields, and the second scheduling indication points to a row for each table separately. The set may be simply a set of values confined to a smaller set comparing to original possible values. For example, the 5 bit MCS DCI field in Release 15 may take one of the possible 32 values, the first scheduling indication may indicate 4 of them as allowed, the second scheduling indication may choose one of the 4 allowed values through a 2-bits field.

In a second option (e.g., partial process 600), some scheduling fields (less dynamic) may be obtained from the first scheduling indication, while other scheduling fields (more dynamic) may be obtained from the second scheduling indication. For example, the first scheduling indication may indicate frequency or time domain resource assignment and antenna port(s) while the second scheduling indication may indicate MCS and downlink assignment index (DAI).

In a third option (e.g., partial process 700), the value of a scheduling field may be obtained from the first scheduling indication, and the second scheduling indication overrides that value when/if necessary. It should be understood that a combination of the first, second and third options may be used for different scheduling fields. In addition, various additional options discussed below may be used alone or in combination with each of the three options listed above or any combination of the three options listed above for the first scheduling indication, for example.

In a first additional option, the first scheduling indication may be configured by a RRC (e.g., the time domain resource assignment field in DCI formats 0_1 and 1_1 may be 0, 1, 2, 3 or 4 bits depending on the number of rows in an RRC-configured table.)

In a second additional option, the first scheduling indication may be signaled by a MAC-CE. The same or different MAC CEs may be used for different scheduling fields (e.g., one MAC CE for frequency domain resource assignment, and another for antenna port(s); or both included in the same MAC CE in the first scheduling indication.

In a third additional option, the first scheduling indication may be signaled by another DCI, possibly on another PDCCH monitoring occasion, CORESET, or search space set. To increase the robustness of the first scheduling indication PDCCH, the PDCCH should be designed very reliably. In addition, it may be beneficial to introduce a confirmation (ACK) on the first scheduling indication (i.e., first DCI).

It may be beneficial to differentiate the first DCI and second DCI based on one or more of i) different radio network temporary identifiers (RNTIs), ii) different DCI formats; iii) different CORESETs or search space sets. In addition, the first scheduling indication may be a regular grant that is sent less frequent compared to the second scheduling indication. The first scheduling indication may be a semi-persistent scheduling (SPS) grant, may be configured through a RRC, and may be activated and/or its parameters may be changed (reactivated) when necessary through a separate RNTI (SPS/CS-RNTI) on PDCCH.

In addition, both first and second scheduling indication may be SPS with the assumption that reactivation of the first scheduling indication happens less frequent than the reactivation of the second scheduling indication. It should be understood that a combination of the first, second, and third additional options may be used with one or more of the first, second, and third options listed above. For example, a RRC may configure a bigger set, a MAC CE may signal a smaller set and second stage DCI may point to one of the members of the set allowed by MAC CE similar to TCI state indication for PDSCH.

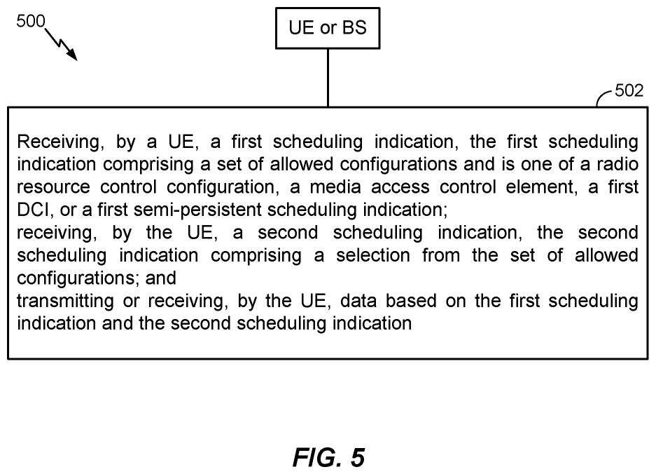

FIGS. 5-7 describe partial processes for configuring a UE or BS. It should be understood that in FIGS. 5-7 when the UE is described as receiving a transmission, a BS may transmit that transmission and vice versus. For example, if the partial process describes receiving, by a UE, a first scheduling indication, it should be understood that this includes transmitting, by a BS, the first scheduling indication.

FIG. 5 illustrates a first exemplary process for configuring a UE or BS in accordance with some examples of the disclosure. As shown in FIG. 5, a partial process 500 may be applicable to an UE (e.g., UE 104, 240, and 350) or a BS (e.g., BS 102, 310, gNB 222, eNB 224) and include 502—receiving, by a UE, a first scheduling indication, the first scheduling indication comprising a set of allowed configurations and is one of a radio resource control configuration, a media access control element, a first DCI, or a first semi-persistent scheduling indication; receiving, by the UE, a second scheduling indication, the second scheduling indication comprising a selection from the set of allowed configurations; and transmitting or receiving, by the UE, data based on the first scheduling indication and the second scheduling indication. Optionally, the partial process 500 may include transmitting, by the UE, an acknowledgement of the received first scheduling indication.

It should be understood that the partial process 500 may also include wherein the set of allowed configurations comprises a set of frequency domain assignments and the selection comprises one of the frequency domain assignments of set of frequency domain assignments; wherein the first scheduling indication comprises a set of modulation coding scheme values and the second scheduling indication comprises a selection from the set of modulation coding scheme values, the set of allowed configurations comprises a table with multiple rows wherein each of the multiple rows contains scheduling information and the selection comprises an indication of one or more of the multiple rows, the first scheduling indication is a radio resource control configuration, the first scheduling indication is a media access control element, the first scheduling indication is received on a first DCI channel and the second scheduling indication is received on a second DCI channel different from the first DCI channel, the first scheduling indication comprises a semi-persistent scheduling indication, the first scheduling indication comprises a first semi-persistent scheduling indication and the second scheduling indication comprises a second semi-persistent scheduling indication, and the first scheduling indication and the second scheduling indication comprises one of different radio network temporary identifiers, different downlink control information formats, different configurable control resource sets, or different PDCCH search space sets.

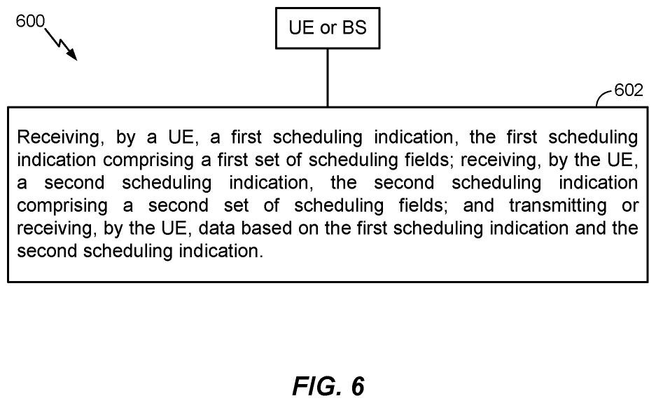

FIG. 6 illustrates a second exemplary process for configuring a UE or BS in accordance with some examples of the disclosure. As shown in FIG. 6, a partial process 600 may be applicable to an UE (e.g., UE 104, 240, and 350) or a BS (e.g., BS 102, 310, gNB 222, eNB 224) and include 602—receiving, by a UE, a first scheduling indication, the first scheduling indication comprising a first set of scheduling fields;

receiving, by the UE, a second scheduling indication, the second scheduling indication comprising a second set of scheduling fields; and transmitting or receiving, by the UE, data based on the first scheduling indication and the second scheduling indication. Optionally, the partial process 600 may include transmitting, by the UE, an acknowledgement of the received first scheduling indication.

It should be understood that the partial process 600 may also include wherein the first set of scheduling information comprises at least one of a frequency domain assignment, a time domain assignment, and antenna port mapping and the second set of scheduling information comprises at least one of a modulation coding scheme and downlink assignment index; the first scheduling indication is a radio resource control configuration; the first scheduling indication is a media access control element; the first scheduling indication is received on a first DCI channel and the second scheduling indication is received on a second DCI channel different from the first DCI channel; the first scheduling indication comprises a semi-persistent scheduling indication; the first scheduling indication comprises a first semi-persistent scheduling indication and the second scheduling indication comprises a second semi-persistent scheduling indication; and the first scheduling indication and the second scheduling indication comprises one of different radio network temporary identifiers, different downlink control information formats, different configurable control resource sets, or different PDCCH search space sets.

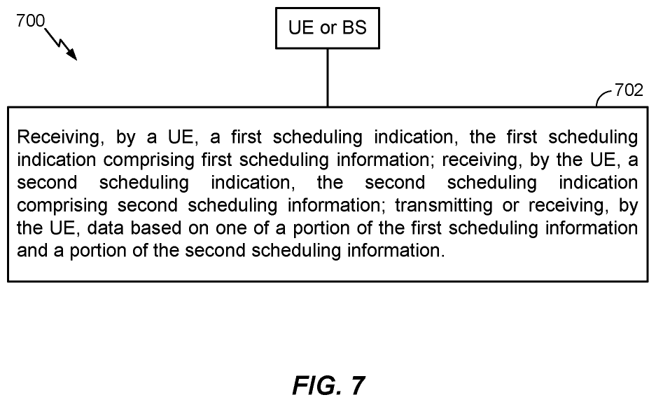

FIG. 7 illustrates a third exemplary process for configuring a UE or BS in accordance with some examples of the disclosure. As shown in FIG. 7, a partial process 700 may be applicable to an UE (e.g., UE 104, 240, and 350) or a BS (e.g., BS 102, 310, gNB 222, eNB 224) and include 702—receiving, by a UE, a first scheduling indication, the first scheduling indication comprising first scheduling information; receiving, by the UE, a second scheduling indication, the second scheduling indication comprising second scheduling information; transmitting or receiving, by the UE, data based on one of a portion of the first scheduling information and a portion of the second scheduling information. Optionally, the partial process 700 may include transmitting, by the UE, an acknowledgement of the received first scheduling indication.

It should be understood that the partial process 700 may also include wherein the first set of scheduling information comprises at least one of a frequency domain assignment, a time domain assignment, and antenna port mapping and the second set of scheduling information comprises at least one of a modulation coding scheme and downlink assignment index; the first scheduling indication is a radio resource control configuration; the first scheduling indication is a media access control element; the first scheduling indication is received on a first DCI channel and the second scheduling indication is received on a second DCI channel different from the first DCI channel; the first scheduling indication comprises a semi-persistent scheduling indication; the first scheduling indication comprises a first semi-persistent scheduling indication and the second scheduling indication comprises a second semi-persistent scheduling indication; and the first scheduling indication and the second scheduling indication comprises one of different radio network temporary identifiers, different downlink control information formats, different configurable control resource sets, or different PDCCH search space sets.

It should be understood that various electronic devices that may be integrated with any of the aforementioned devices in accordance with some examples of the disclosure. For example, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle. The listed devices are merely exemplary. Other electronic devices may also feature the integrated device that store or retrieve data or computer instructions, or any combination thereof.

It will be appreciated that various aspects disclosed herein can be described as functional equivalents to the structures, materials and/or devices described and/or recognized by those skilled in the art. For example, in one aspect, an apparatus may comprise a means for storing information (e.g., memory 376 and memory 360 of FIG. 3); a means for processing (e.g., processor 375, 316, 370, 356, 359, and 368 of FIG. 3) coupled to the means for storing information, and a means for transmitting and receiving RF signals (e.g., antenna 320 and antenna 352 of FIG. 3)) coupled to the means for processing; wherein the means for processing is configured to perform any of the methods or functions described herein. It will be appreciated that the aforementioned aspects are merely provided as examples and the various aspects claimed are not limited to the specific references and/or illustrations cited as examples.

One or more of the components, processes, features, and/or functions illustrated in FIGS. 1-7 may be rearranged and/or combined into a single component, process, feature or function or incorporated in several components, processes, or functions. Additional elements, components, processes, and/or functions may also be added without departing from the disclosure. It should also be noted that FIGS. 1-7 and its corresponding description in the present disclosure is not limited to dies and/or ICs. In some implementations, FIGS. 1-7 and its corresponding description may be used to manufacture, create, provide, and/or produce integrated devices.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE), IEEE 802.11 (WiFi), and IEEE 802.15.4 (Zigbee/Thread) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method of operating an user equipment (UE), comprising:
receiving, by a UE, a first scheduling indication, the first scheduling indication comprising a set of allowed configurations and is one of a radio resource control configuration, a media access control element, a first DCI, or a first semi-persistent scheduling indication;
receiving, by the UE, a second scheduling indication, the second scheduling indication comprising a selection from the set of allowed configurations; and
transmitting or receiving, by the UE, data based on the first scheduling indication and the second scheduling indication.

2. The method of operating of claim 1, wherein the set of allowed configurations comprises a set of frequency domain assignments and the selection comprises one of the frequency domain assignments of set of frequency domain assignments.

3. The method of operating of claim 1, wherein the first scheduling indication comprises a set of modulation coding scheme values and the second scheduling indication comprises a selection from the set of modulation coding scheme values.

4. The method of operating of claim 1, wherein the set of allowed configurations comprises a table with multiple rows wherein each of the multiple rows contains scheduling information and the selection comprises an indication of one or more of the multiple rows.

5. The method of operating of claim 1, wherein the first scheduling indication is the first DCI and the second scheduling indication is a second DCI different from the first DCI.

6. The method of operating of claim 5, further comprising transmitting, by the UE, an acknowledgement of the received first scheduling indication.

7. The method of operating of claim 5, wherein the first scheduling indication comprises the semi-persistent scheduling indication.

8. The method of operating of claim 5, wherein the first scheduling indication comprises the first semi-persistent scheduling indication and the second scheduling indication comprises a second semi-persistent scheduling indication.

9. The method of operating of claim 5, wherein the first scheduling indication and the second scheduling indication comprises one of different radio network temporary identifiers, different downlink control information formats, different configurable control resource sets, or different PDCCH search space sets.

10. A method of operating an user equipment (UE), comprising:
receiving, by a UE, a first scheduling indication, the first scheduling indication comprising a first set of scheduling fields and is one of a radio resource control configuration, a media access control element, or a first DCI;
receiving, by the UE, a second scheduling indication, the second scheduling indication comprising a second set of scheduling fields; and
transmitting or receiving, by the UE, data based on the first scheduling indication and the second scheduling indication.

11. The method of operating of claim 10, wherein the first scheduling indication comprises at least one of a frequency domain assignment, a time domain assignment, and antenna port mapping and the second scheduling indication comprises at least one of a modulation coding scheme and downlink assignment index.

12. The method of operating of claim 10, wherein the first scheduling indication is the first DCI and the second scheduling indication is a second DCI different from the first DCI.

13. The method of operating of claim 10, wherein the first scheduling indication comprises a semi-persistent scheduling indication.

14. The method of operating of claim 10, wherein the first scheduling indication comprises a first semi-persistent scheduling indication and the second scheduling indication comprises a second semi-persistent scheduling indication.

15. The method of operating of claim 14, wherein the first scheduling indication and the second scheduling indication comprises one of different radio network temporary identifiers, different downlink control information formats, different configurable control resource sets, or different PDCCH search space sets.

16. An user equipment (UE), comprising:
a processor;
a memory coupled to the processor; and
an antenna coupled to the processor;
wherein the processor is configured to perform a method comprising:
receiving a first scheduling indication, the first scheduling indication comprising a set of allowed configurations and is one of a radio resource control configuration, a media access control element, a first DCI, or a first semi-persistent scheduling indication;
receiving a second scheduling indication, the second scheduling indication comprising a selection from the set of allowed configurations; and
transmitting or receiving data based on the first scheduling indication and the second scheduling indication.

17. The UE of claim 16, wherein the set of allowed configurations comprises a set of frequency domain assignments and the selection comprises one of the frequency domain assignments of set of frequency domain assignments.

18. The UE of claim 16, wherein the first scheduling indication comprises a set of modulation coding scheme values and the second scheduling indication comprises a selection from the set of modulation coding scheme values.

19. The UE of claim 16, wherein the set of allowed configurations comprises a table with multiple rows wherein each of the multiple rows contains scheduling information and the selection comprises an indication of one or more of the multiple rows.

20. The UE of claim 16, wherein the first scheduling indication is the first DCI and the second scheduling indication is a second DCI different from the first DCI.

21. The UE of claim 16, wherein the first scheduling indication comprises the first semi-persistent scheduling indication and the second scheduling indication comprises a second semi-persistent scheduling indication.

22. The UE of claim 16, wherein the first scheduling indication and the second scheduling indication comprises one of different radio network temporary identifiers, different downlink control information formats, different configurable control resource sets, or different PDCCH search space sets.

23. An user equipment (UE), comprising:
a processor;
a memory coupled to the processor; and
an antenna coupled to the processor;
wherein the processor is configured to perform a method comprising:
receiving a first scheduling indication, the first scheduling indication comprising a first set of scheduling fields and is one of a radio resource control configuration, a media access control element, or a first DCI;
receiving a second scheduling indication, the second scheduling indication comprising a second set of scheduling fields; and
transmitting or receiving data based on the first scheduling indication and the second scheduling indication.

24. The UE of claim 23, wherein the first set of scheduling information comprises at least one of a frequency domain assignment, a time domain assignment, and antenna port mapping.

25. The UE of claim 24, wherein the second set of scheduling information comprises at least one of a modulation coding scheme and downlink assignment index.

26. The UE of claim 23, wherein the first scheduling indication is the first DCI and the second scheduling indication is a second DCI different from the first DCI or a semi-persistent scheduling indication.

27. The UE of claim 23, wherein the first scheduling indication and the second scheduling indication comprises one of different radio network temporary identifiers, different downlink control information formats, different configurable control resource sets, or different PDCCH search space sets.

28. The UE of claim 23, wherein the first scheduling indication comprises a first semi-persistent scheduling indication and the second scheduling indication comprises a second semi-persistent scheduling indication.

29. The method of operating of claim 23, wherein the first scheduling indication and the second scheduling indication comprises one of different radio network temporary identifiers, different downlink control information formats, different configurable control resource sets, or different PDCCH search space sets.
